(19) United States
(12) Patent Application Publication
(10) Pub. No.: US 2004/0117352 A1
(43) Pub. Date: Jun. 17, 2004

(54) System for answering natural language questions

(75) Inventors: Yves Schabes, Newton, MA (US); Emmanuel Roche, Belmont, MA (US)

Correspondence Address: ATTORNEY/AGENT, Choate, Hall & Stewart, 53 State Street, Exchange Place, Boston, MA, 02109, US

(73) Assignee: Global Information Research and Technologies LLC, Boston, MA

(21) Appl. No.: 09/845,571

(22) Filed: Apr. 30, 2001

Related U.S. Application Data
(60) Provisional application No. 60/200,766, filed on Apr. 28, 2000.

(51) Int. Cl. G06F 7/00

(52) U.S. Cl. 707/3

(57) ABSTRACT

The present invention is a system for answering a natural language question. The system receives a question and transforms the question into one or more partially unspecified queries. The system then identifies matches for the queries in a body of information. The matches are optionally ranked, preferably based on the number of times each match is identified. The matches are provided as answers to the questions.

This application claims the benefit of U.S. Provisional Application No. 60/200,766, filed Apr. 28, 2000.

This application incorporates by reference in their entirety the contents of a computer program listing appendix containing six files created Apr. 30, 2001, entitled “Example_Match_Input.txt” (19 KB), “Example_Output.txt” (20 KB), “frames.pm” (93 KB), “frames.txt” (115 KB), “makemap.pl” (33 KB), and “match.pl” (41 KB) submitted on two duplicate compact disks with this application.

### FIELD OF THE INVENTION

The present invention relates to a system that processes a natural language question and provides an answer or answers to the question based on a body of information such as a collection of documents. The invention has particular utility in connection with text indexing and retrieval systems, such as retrieval of information from the World Wide Web.

### BACKGROUND OF THE INVENTION

Information retrieval systems are designed to store and retrieve information provided by publishers covering different subjects. Information retrieval engines are provided within prior art information retrieval systems in order to receive search queries from users and perform searches through the stored information. It is an object of most information retrieval systems to provide the user with all stored information relevant to the query. However, many existing searching/retrieval systems are not adapted to identify the best or most relevant information yielded by the query search. Such systems typically return query results to the user in such a way that the user must retrieve and view every document returned by the query in order to determine which document(s) is/are most relevant. For example, such a system may provide, in response to a natural language question, a mapping to other information sources or other questions the system considers to be relevant or similar to the question the searcher asked, but not a straightforward answer to the natural language question. It is therefore desirable to have a document searching system which not only returns a list of relevant information to the user based on a query search, but also returns the information to the user in such a form that the user can readily identify which information returned from the search is most likely the answer to the question posed.

The quality of solutions to a query provided by an information retrieval system will depend, in part, upon the method utilized by the information retrieval system to determine the best match in a body of information such as a collection of documents, and also in part upon the form of the query received. Existing systems do not preanalyze the searched text, and therefore are required to conduct syntactic analysis each time a question is asked. Traditional search engines first identify a set of candidate documents in which relevant information may be found, and then read the identified documents in order to locate information. Such an approach suffers from two major drawbacks. First, it is time consuming because so many documents are typically retrieved, and because so much reading of documents to extract information is required. For example, queries issued on Internet search engines can retrieve thousands or even millions of documents. Second, although search engines try to rank documents from the most relevant to the least relevant, they do not perform an assessment of the results of the query across multiple documents.

An information retrieval system that allows a user to specify his or her query in the form they might ask the question naturally could potentially limit the over-inclusiveness of traditional keyword searching. Since, in traditional search systems, it is not possible to place any restrictions on the text between or around the search terms, a user is likely to encounter a great deal of material that is irrelevant to the actual information desired. On the other hand, an information retrieval system that allows matching to be conducted without strict ordering of query terms, and that linguistically analyzes the query and searched body of information, could potentially alleviate the under-inclusiveness of rigid, ordered keyword searching.

### SUMMARY OF THE INVENTION

In one aspect, the invention is a system (e.g., a method, an apparatus, and computer-executable process steps) for providing an answer to a natural language question. The invention accepts a natural language question and transforms the question into one or more partially unspecified queries. The system then identifies matches for the partially unspecified queries. A match for a query constitutes an answer to the question from which it is derived. In certain embodiments of the invention a plurality of answers is obtained and optionally ranked. Identifiers and/or locations for documents in which an answer is found may be returned in addition to or instead of the answer(s) themselves. The system is capable of answering questions in a number of formats, including some questions that are posed in a manner requiring a response in the affirmative or negative.

By automatically extracting information from documents, the system overcomes the limitations described above. First, the documents indexed are automatically analyzed by linguistic tools in anticipation of extracting information from the entire body of documents as a whole. Second, the inventive system accepts richer queries in which specific terms are used to identify the information requested in addition to search keywords. Third, the entire body of documents is treated as a unique source of information, and the inventive system returns in order of global frequency the actual answers that match the query instead of the list of documents that contain a match for the keywords of the query. The answers are collected across all documents which match the query, thus turning the overwhelming number of documents into an information source for computing the relevant information and returning one or more actual answers to the natural language question.

In other aspects, the invention is a contextual thesaurus and methods for using a contextual thesaurus to expand a question or statement into multiple equivalent questions or statements in which words or phrases are replaced by alternative words or phrases in a manner that preserves the meaning of the original text.

### BRIEF DESCRIPTION OF THE DRAWINGS

FIG. 1 is a schematic diagram depicting the operating environment of the invention.

FIG. 2 is flow diagram illustrating the overall process of obtaining an answer or answers for a natural language question.

FIG. 3 is a flow diagram illustrating the process for obtaining matches for a set of partially unspecified queries that correspond to a natural language question.

FIG. 4 is an illustration of an index data structure.

FIG. 5 is an illustration of an example of a weighted finite state transducer.

### DETAILED DESCRIPTION

Preferred embodiments of the invention will now be described with reference to the accompanying drawings.

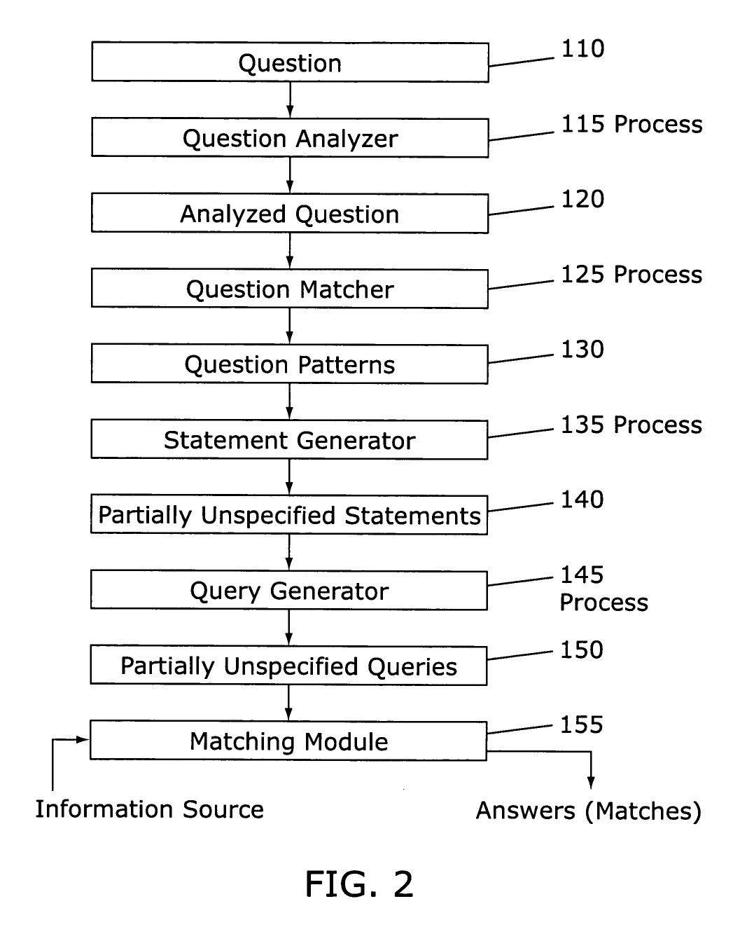

The invention may be implemented on a networked computer such as that shown in FIG. 2 of Applicants' pending U.S. National Application titled “System for Fulfilling an Information Need”, U.S. Ser. No. 09/559,223, filed Apr. 26, 2000 (hereinafter “the Information Need application”), the contents of which are hereby incorporated by reference in their entirety. Also incorporated in their entirety are the contents of Applicants' pending U.S. Provisional Application titled “System for Fulfilling an Information Need Using an Extended Matching Technique”, U.S. Ser. No. 60/251,608, filed Dec. 5, 2000 (hereinafter “the Extended Matching application”). The Extended Matching application builds upon the Information Need application, describing a technique for the identification of matches in documents in which the appearance of query terms are unordered or only partially specified with respect to the matches and in which there may be intervening words between the matching terms.

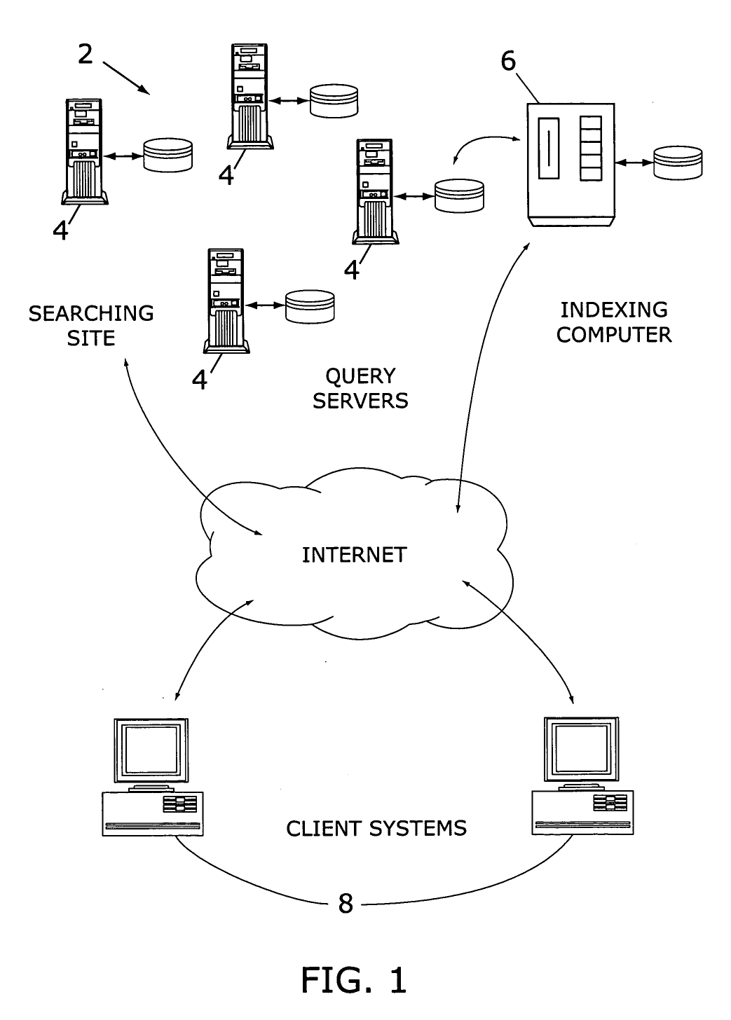

As described in the Information Need application and depicted in FIG. 1, a searching site 2 comprising one or more query servers 4 and one or more indexing computers 6, is logically connected (e.g., via the Internet) to one or more client computer systems 8. Computers within searching site 2 may be connected to one another via a local area network, intranet, etc. A natural language question, may be entered into a client system 8 by a user at a remote location and transmitted over the network to searching site 2. The question may be processed at searching site 2, and results for the question (e.g., one or more answers) transmitted to client system 8 for display to the user. Of course in certain embodiments of the invention questions can also be entered directly into query servers 4 at searching site 2.

Question Answering by Transforming Questions into Partially Unspecified Queries

Applicants' pending Information Need application mentioned above provides a system for fulfilling an information need by providing a result for a partially unspecified query based on a body of information such as a collection of documents in a database (e.g., a collection of World Wide Web pages). As described therein, a partially unspecified query contains one or more unspecified terms. An unspecified term is generally represented by a special symbol such as an underscore character. In the present application an underscore is used to represent an unspecified term. An unspecified term can by wholly unspecified or partially unspecified. For example, the query

_invented the telephone

contains a wholly unspecified term. A partially unspecified term is represented by a special symbol followed by a restriction. For example, the following query:

Agatha Christie was born _[DATE]

contains a partially unspecified term with the restriction [DATE]. Applicants' applications mentioned above describe systems that identify matches for queries within a body of information such as documents in a database. The criteria for a match are defined in greater detail therein. Briefly, any term can match a wholly unspecified term. For a partially unspecified term, any term or group of terms that satisfies the restriction constitutes a match. Thus only a date will match the partially unspecified term _[DATE] in the query above.

The structure of a partially unspecified query permits expression of a specific information need in a novel way. In contrast to traditional searching systems wherein a user specifies the term, perhaps accompanied by a delimiter, the Applicants' previously mentioned applications allow the user to specify some feature of the information being sought. By finding matches for such a query the information need can be effectively fulfilled. In particular, by identifying a plurality of matches among a plurality of documents and then ranking the matches according to any of a variety of metrics (e.g., the number of times an instance of a match is located, or an indication of the reliability of a match), a user can be directed to those results that are more likely to be appropriate. Either the matches themselves, or portions thereof, can be returned as results for a query. Per the technique introduced in the Extended Matching application, the matching terms need not appear in the same relative order as in the query and there may be intervening words between the matching terms. Alternatively, the query terms may be partially or completely specified.

Although a system for providing results for a partially unspecified query considerably facilitates the task of retrieving information related to a specific need from a large body of information, it does not fully address a major goal in the field of information retrieval, namely providing answers to questions expressed in natural language. The present invention provides a system for and method of accomplishing this task. According to the present invention, a natural language question is transformed into one or more partially unspecified queries as described in more detail below. Matches are identified for the partially unspecified queries that correspond to the natural language question. In preferred embodiments of the invention, the portion of a match that corresponds to a partially unspecified term in the query is identified and/or stored. For the purposes of the present application, the portion of a match that corresponds to a partially unspecified term in a query, rather than the complete string that matches the query, will be referred to as a match. For example, one complete match for the query

Agatha Christie was born _[DATE]

is the phrase Agatha Christie was born in 1890. For purposes of this application, the portion of this complete match that corresponds to (i.e., matches) the partially unspecified term _[DATE] (in this case the date in 1890) constitutes a match for the query. In preferred embodiments of the invention a score is assigned to each match, and the matches are ranked. In general, the processes of matching, assigning scores, and ranking matches for a partially unspecified query are performed as described in the Information Need application mentioned above. In the case that a question is transformed into multiple queries, the matches and their associated scores are appropriately combined, and the matches are ranked based on the combined score as described in more detail below. In a preferred embodiment of the invention, a ranked list of matches, or the match that receives the highest ranking, is returned as an answer to the question. The rationale for the inventive system relies on the existence of large bodies of information such as the set of World Wide Web pages or a subset thereof. Within such a large body of information, the likelihood that the answer to a question is present in the form of a corresponding statement is very high. Furthermore, it is likely that multiple instances of statements that constitute a potential answer for a question will exist within the body of information. Most such statements are likely to be accurate. Thus, by relying on the sheer volume of information available, and by ranking the identified answers (based, e.g., on frequency), the inventive system can effectively identify correct answers to a wide range of questions. For those ordered searches which fail to return a sufficient number of search results, the unordered query techniques of the Extended Matching application provides expanded search capabilities.

The processes of (1) transforming a natural language question into one or more partially unspecified queries; (2) identifying matches for the queries; (3) combining matches obtained for multiple queries; and (4) providing answers will now be discussed in further detail.

Using Syntactic Frames to Identify Question Patterns within Linguistically Analyzed Questions

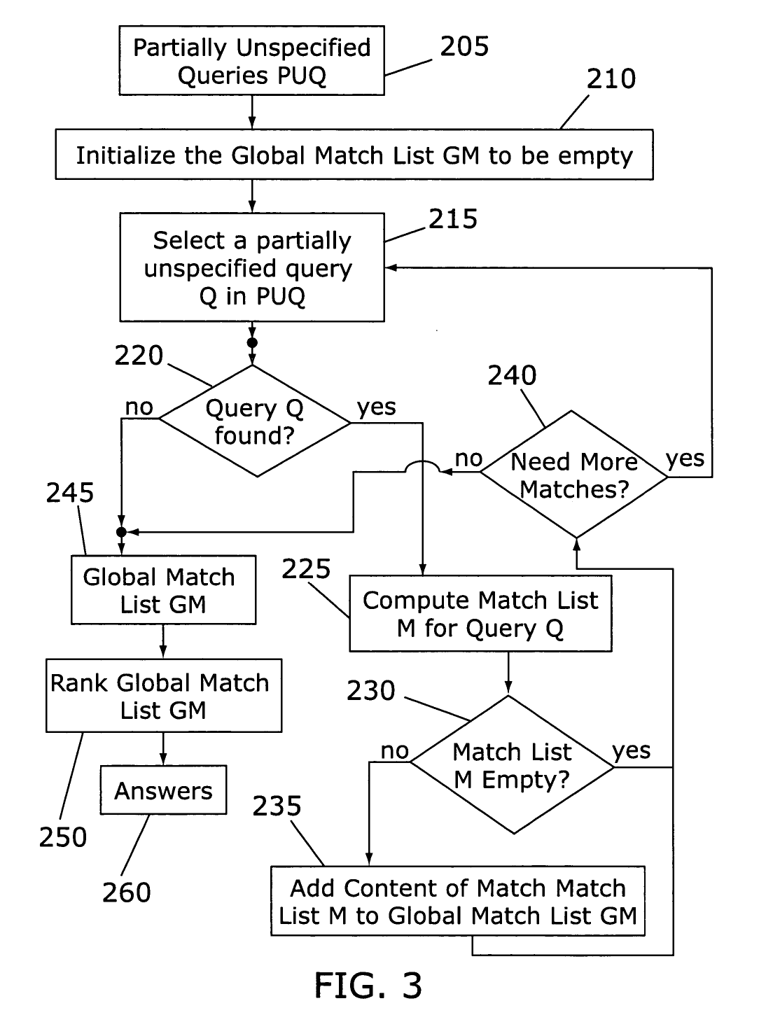

FIGS. 2 and 3 illustrate an embodiment of the method of the present invention. FIG. 2 illustrates the steps by which a natural language question 110 is transformed into one or more partially unspecified queries 150. The task of transforming natural language question 110 into one or more partially unspecified queries 150 can be considered as a two-step process, in which natural language question 110 is first transformed into one or more corresponding partially unspecified statements 140 by statement generator 135. The partially unspecified statements 140 are then transformed into the partially unspecified queries 150 by query generator 145. With regard to the first transformation process, partially unspecified statements 140 that corresponds to natural language question 110 are statements that parallel, in structure, an answer to natural language question 110. However, partially unspecified statements 140 do not in fact contain an appropriate answer to natural language question 110 but instead contains a word or words that reflects the item of information required to answer natural language question 110. Such a word will be referred to herein as a question word. Note that in many instances there are numerous partially unspecified statements 140 that corresponds to a particular question. For example, the natural language question 110

Who invented the telephone?

is transformed into the following partially unspecified statements 140:

(1) WHO invented the telephone

(2) The telephone was invented by WHO

The question word WHO in the above partially unspecified statements 140 reflects the fact that an appropriate answer to natural language question 110 is the name of a human being. As another example, the natural language question 110

When was Agatha Christie born?

is transformed to the following partially unspecified statement (among others):

Agatha Christie was born WHEN

The question word WHEN in the above partially unspecified statement 140 reflects the fact that an appropriate answer to natural language question 110 is a time adverbial such as a date. Referring to FIG. 2, partially unspecified statements 140 are derived through the operation of statement generator 135 upon question patterns 130. Question patterns 130 are derived through the operation of question matcher 125 upon analyzed question 120, during which question matcher 125 matches analyzed question 120 to a set of predetermined question patterns (contained in tables as described below). Question patterns 130 are those patterns that match. Analyzed question 120 is the output of question analyzer 115, which takes as input natural language question 110 and subjects it to a syntactic and morphological analysis. The analysis assigns an appropriate combination of syntactic and/or morphological categories (e.g., noun phrase, verb phrase, verb tense) to various portions of natural language question 110. Techniques for performing such textual analysis are known in the art and are described, for example, in Woods, W. A., Transition Network Grammars for Natural Language Analysis, Communications of the ACM, Vol. 13, No. 10, October, 1970; Roche, E., Looking for Syntactic Patterns in Texts in Papers in Computational Lexicography. Complex '92, Kiefer, F., Kiss, G., and Pajzs, J. (eds.) Linguistic Institute, Hungarian Academy of Sciences, Budapest, pp. 279-287; Karp, Schabes, Zaidel, and Egedi, A Freely Available Wide Coverage Morphological Analyzer for English, Proceedings of the 15^{th} International Conference on Computational Linguistics, Nantes, pp. 950-954, 1992. The contents of the preceding references are hereby incorporated by reference in their entirety.

The partially unspecified statements 140 that correspond to particular question patterns 130 are equivalent in that they both have a structure corresponding to an appropriate answer to the question. By a simple mapping, statement generator 135 converts the question patterns 130 into the corresponding statement patterns 140, which are expressed in terms of syntactic and/or morphological categories. Statement patterns 140 are provided to query generator 145, which transforms them into one or more partially unspecified queries 150. The operation of query generator 145 is described in more detail below. The queries are passed to matching module 155, which identifies matches for the queries. The operation of matching module 155 is also described in more detail below and illustrate in FIG. 3. The matches obtained by matching module 155 are provided as answers 260 to the question. In preferred embodiments of the invention, the matches are ranked and are output in an order based on the ranking. In certain embodiments of the invention identifiers and/or locations of documents in which an answer is identified are also provided as part of the output.

The following examples illustrate the processes of question analyzer 115, question matcher 125 which identifies appropriate question patterns 130, statement generator 135 which generates partially unspecified statements 140, and query generator 145 which transforms partially unspecified statements 140 into partially unspecified queries 150. A natural language question 110 is analyzed and matched against a set of question patterns. The matching question pattern (or patterns) 130 is then transformed into one or more statement patterns 140. The statement patterns 140 are then converted into query patterns, which are finally transformed into partially unspecified queries 150. The examples provide representative answers obtained by the inventive method. The examples are distinguished by the form of question word associated with the natural language question 110.

The Applicants have a working software application, which comprises an actual reduction to practice of the present invention. The software application employs three tables, framemap1, framemap2, and adjframes that are automatically generated from another table FRAMES. A FRAME is a set of phrases that have been derived through transformations to have different structure but the same informational content as a specific declarative sentence or an appropriate question word substituted in the phrase. The set of FRAMES presented at the end of the “Detailed Description” portion of the current application is not at all meant to be limiting, there are potentially many more FRAMES than included therein. Each non-question FRAME also includes -A and -AH adjunct modifiers/markers. These indicate the possible positions adjuncts can occur. -A represents any adjunct (time, manner, etc.), while -AH only represents manner. -A can be an appropriate position for an answer to a WHEN or HOW question. -AH can be an appropriate place of a response to a HOW question. -AT may also be used to designate a slot in which only a time adjunct modifier may appear. All the possible adjunct modifier positions are listed when a transformation is listed, but a process of the software application ensures that only one adjunct modifier position is possible at a time. The typical contents of a FRAME are demonstrated by FRAME 1, which is comprised of the declarative sentence

the boy danced (-A NP0 -AH V -A)

and the possible set of grammatical transformations

WH0 V? who danced?

NP0 REL -AH V -A the boy who danced

NP0 V(ing) -A the boy dancing

DET A N0 the dancing boy.

Framemap1 is attached at the end of this “Detailed Description” section and comprises a table in which the key is of the form “WH NP V” and the associated value is of the form “WH1 NP0 V”. This table is used to assign the proper numerical indexing to nouns and prepositions. The numerical indexes are necessary to keep track of corresponding nouns and prepositions which move as a frame rearranges into various phrase forms.

Framemap2 is attached at the end of this “Detailed Description” section and comprises a table which has keys in the form of “WH1 NP0 V”. Framemap2 returns an associated value of the form “NP0 V; NP0 REL V; NP0 V(ing)”. The associated value lists all the possible transformations associated for that FRAME. Framemap2 is used to derive all the possible transformations for a given FRAME. On the right side of each arrow in framemap2 are all the potential affirmative statement structures which may be configured from a given query structure.

Adjframes is attached at the end of this “Detailed Description” section and comprises a table which has keys of the form “NP0 V” and associated values of the form “-A NP0 V; NP0 -AH V; NP0 V -A”. This table is used to find the possible places adjuncts can be inserted into a given FRAME.

The foregoing examples use some or all of the following grammatical notations:

WH stands for question-word (who, what, whom, . . . )

WHP stands for question-word phrase

AUX stands for any auxiliary verb (did, will, . . . )

DATE stands for a time or date restriction

DET stands for a determiner (a, the, . . . )

N stands for noun

NP stands for noun-phrase

V stands for verb, all possible forms

V-passive stands for verb in passive form

NHUM stands for a person's name restriction

REL stands for relative clause marker (who/which)

RELM stands for relative clause marker (whom/which)

-A stands for any type of adjunct

-AH stands for a manner-only adjunct

-AT stands for a time-only adjunct

? indicates the transformation is a question

# indicates the remainder of the line are comments

EX: indicates the entire line is a comment

WHO/WHAT QUESTIONS:

As a first example, consider the natural language question 110

Who did the boy see?

Question analyzer 115 recognizes the word Who as a question word, the word did as auxiliary, the as a determiner, boy as a noun, the boy as a noun phrase, and see as a verb, in deriving analyzed question 120

(*WH who) (*A UX did) (*NP (*DET the) (*N boy)) (*V see)?

Next, the analysis is simplified by ignoring all the question terms and auxiliary verbs and by ignoring the content of noun phrases to derive

WH NP V,

which is then looked up in table framemap1 by question matcher 125 to find a corresponding numerically indexed phrase, or question pattern 130, namely

WH1 NP0 V.

Next, in the step corresponding to the action of statement generator 135, question pattern 130 is matched by look up into framemap2 to obtain all possible transformations (within the quotes on the right side of the arrow, separated by semi colons) into affirmative statement patterns 140:

“WH1 NP0 V”=>“NP0 V NP1; NP1 REL NP0 V;NP1 NP0 V;NP1 V(PastP) BY NP0;NP1 V(Passive) BY NP0;NP0 REL NP1 V(Passive) BY;NP0 NP1 V(Passive) BY;NP0 BY RELM NP1 V(Passive0;NP1 REL V(Passive) BY NP0”.

Since the question begins with WH1 and it was a “who” question, all occurrences of a symbol followed by “1” are replaced by NHUM, the symbol standing for Noun Human:

NP0 VNHUM

NHUM REL NP0 V

NHUM NP0 V

NHUM V(PastP) BY NP0

NHUM V(PaSsive) BY NP0

NP0 REL NHUM V(Passive) BY

NP0 NHUM V(Passive) BY

NP0 BY RELM NP1 V(Passive)

NHUM REL V(Passive) BY NP0.

Next, query generator 145 transforms the statement patterns into partially unspecified queries 150 by replacing the question word with each of the appropriate restrictions (to form query patterns) and by then replacing the syntactic and/or morphological categories with the corresponding terms from the input natural language question 110, resulting in

the boy saw [NHUM]

[NHUM] who the boy saw

[NHUM] the boy saw

[NHUM] seen by the boy

[NHUM] has been seen by the boy

the boy who [NHUM] was seen by

the boy [NHUM] was seen by

the boy by whom [NHUM] was seen

[NHUM] who was seen by the boy.

These resulting partially unspecified queries 150 are passed to matching module 155, which performs the actual matching to obtain an answer to input question 110.

WHERE/WHEN QUESTIONS

Assume the input natural language question 110 is

When did Bell invent the telephone?

Parser analysis yields

(*WHEN when) (*A UX did) (*NP (*N Bell)) (*V invent) (*NP (*DET the) (*N telephone)) ?

Then, as in the previous example, the analysis is simplified by ignoring then question words, all determiners, auxiliary verbs, and the content of noun phrases:

WHEN NP V NP.

Using framemap1 (while ignoring WHEN) yields

NP V NP=>NP0 V NP1,

and then NP0 V NP1 is looked up into framemap2 to obtain

NP0 V NP1=>NP0 V NP1; NP1 REL NP0 V; NP1 NP0 V; NP1 V(PastP) BY NP0; NP1 V(Passive) BY NP0; NP0 REL NP1 V(Passive) BY; NP0 NP1 V(Passive) BY; NP0 BY RELM NP1 V(Passive); NP1 REL V(Passive) BY NP0.

This step provides all possible FRAMES, or structural variants containing the same information, in which the sentence “Bell invented the telephone” can occur. Then each of those FRAMES are looked up into the adjframes table to determine where modifiers (temporal in this case) may be placed. For example, the first two FRAMES will yield:

| | |
|---|---|
| NP0 V NP1 => | −A NP0 V NP1 |
| | NP0 −AH V NP1 |
| | NP0 V −AH NP1 |
| | NP0 V NP1 −A |
| NP1 REL NP0 V => | NP1 REL NP0 −AH V |
| | NP1 REL NP0 V −A |

Then the adjunct modifiers are adapted to the question, and the terms from the original natural language question 110 are reinserted to derive partially unspecified queries 150 as follows:

[DATE] Bell invented the telephone

Bell [DATE] invented the telephone

Bell invented [DATE] the telephone

Bell invented the telephone [DATE]

The telephone which Bell [DATE] invented

The telephone which Bell invented [DATE]

“HOW MANY” QUESTIONS

“How many Noun” questions are handled in a very similar fashion to “What” type questions. First, “how many noun” is replaced by “what” in the question. Then, the middle steps of the process are identical. The final step replaces “what” by “Number-Phrase Noun”. For example, the natural language question 110

How many novels did Agatha Christie write?

is transformed into partially unspecified query 150 (among others)

Agatha Christie wrote _[NUM] novels

which will match the following text

Agatha Christie wrote more than sixty novels.

and will give the following answer

More than sixty.

WHY QUESTIONS

WHY questions are handled very much like WHEN questions. First the word WHY is removed from a natural language question 110. An affirmative question results from this deletion. Then the transformations are applied and the positions of adjunct modifiers are looked up in the adjframes table. Finally, any adjunct modifier positions (-A -AH) are replaced by WHY. At query time, WHY should match expressions such as “because ______”, “in order to ______”.

HOW QUESTIONS

HOW questions are handled like WHY questions, in which WHY is replaced by HOW.

Transformation of Statement Patterns into Partially Unspecified Queries

The operation of query generator 145 will now be described in further detail. Query generator 145 receives statement patterns 140 as input and may access the contents of original natural language question 110. Statement patterns 140 contain a question word and syntactic or morphological categories that correspond to elements in original natural language question 110. In order to perform the transformation, in general, the question word is replaced by a partially unspecified term having a restriction that corresponds to the question word. Briefly, transformation of an affirmative statement into a partially unspecified query 150 involves a mapping between a question word or words (or the equivalent) and one or more appropriate partially unspecified term(s). The particular mapping will vary depending upon the specific restrictions associated with partially unspecified terms that are employed in any given implementation of the inventive system. The table below presents a partial mapping of question words (left column) to partially unspecified terms associated with appropriate restrictions (middle column). The column on the right provides a brief explanation of the restrictions.

| Question word | Unspecified query | Explanation |
|---|---|---|
| Who | _[NHUM] | Human name |
| What | _[NP] | Noun phrase |
| What | _[LOCATION] | Location |
| Where | _[LOCATION] | Location |
| When | _[DATE] | Date |
| When | _[TIME] | Time |
| How many | _[NUMBER] | Number |
| At what time | _[TIME] | Time |
| In which nation | _[LOCATION] | Location |
| How ADJECTIVE | _[MEASURE] | Unit of measure |

It will be appreciated that in preferred embodiments of the invention, additional restrictions are employed in order to be able to perform appropriate mappings for as wide a variety of questions as possible. Query generator 145 identifies the restrictions to which a question word in an input statement maps, and replaces the question word in the input statement with each such restriction. For example, the question word WHEN maps to the restriction _[DATE] and _[TIME]. Therefore, in a partially unspecified statement 140 in which the question word WHEN appears, the word WHEN is replaced with the restriction _[DATE] to form one partially unspecified query 150 and with the restriction [TIME] to form a second partially unspecified query 150. Thus a WHEN question is transformed into at least two queries since WHEN maps to two restrictions.

The second aspect of transforming a statement pattern 140 into a partially unspecified query 150 involves replacing the generic syntactic and/or morphological categories in the statement patterns 140 with the corresponding elements from input natural language question 110. This process may involve operating on certain words in input question 110 in order to derive the appropriate form or ordering of words with which to replace the syntactic and/or morphological categories. Such operations are performed in a standard manner as described in the references to textual analysis mentioned above.

For purposes of description, the transformation of a natural language statement 110 into a partially unspecified query 150 has been presented overall as a two step process in which the question is first transformed into a statement having a question word and the statement is then transformed into a partially unspecified query. However, it is to be understood that the process may take place in a single step. The discussion above describes the overall operations performed by the inventive system but are not intended to be limiting in anyway. In particular, the discrete steps described above may be combined and may be distributed among various modules of code (i.e., computer-executable process steps) in any of a variety of ways. The system may also be extended to languages other than English in accordance with the grammatical rules of such languages, and answers to questions in a non-English language can be obtained by identifying matches within a body of information expressed in the particular language of the question.

Identifying Matches for Partially Unspecified Queries and Providing Answers

A flow diagram showing the operation of matching module 155 in a preferred embodiment of the invention is presented in FIG. 3. In brief, matching module 155 operates on partially unspecified queries 150 to obtain a global match list, which includes matches for all of the queries, which (as described above) are equally weighted for the present purposes. In step 205, matching module 155 receives a set of partially unspecified queries 150 corresponding to an input natural language question 110. In step 210, the global match list GM is initialized to be empty. In step 215, a partially unspecified query Q from the set of partially unspecified queries 150 is selected. At decision point 220, if a query is found, processing proceeds to step 225 in which matches for the query are identified. A match list M (with associated scores for the matches) for Q is assembled. Methods for identifying matches and assigning a score to a match are fully described in the Information Need application mentioned above. Briefly, the score reflects the occurrence of a match among a plurality of documents. At decision point 230, if the match list M for Q is non-empty (i.e., if matches for Q were identified in the 18 preceding step), the matches in M are added to global match list GM in step 235. Control then passes to decision point 240. If more matches are needed (which can be determined according to any of a variety of criteria such as those described in the Information Need application), then processing returns to step 215, in which a different partially unspecified 5 query is selected from the set of partially unspecified queries 150. If, on the other hand, no more matches are needed, processing proceeds to step 245 in which the global match list GM is processed as described below. Returning to decision point 230, if match list M is empty (i.e., no matches were found for query Q), processing goes directly to step 240 and proceeds as described above.

Returning to step 245, it will be appreciated that the same match may be identified as a match for multiple partially unspecified queries. Each such match will have its own associated score in each match list M corresponding to a query for which the match was identified. Processing of global match list GM entails combining the matches and associated scores obtained as results for the individual queries to obtain a combined score for each distinct match. For example, if match A appears in match list M₁ with a score of X, and match A also appears in match list M₂ with a score of Y, then in the processed global match list match GM A appears with a combined score of X+Y. Note that processing of the global match list GM may alternatively take place as the matches for individual queries are identified. However, for purposes of illustration it is described herein as occurring in a separate step.

Step 250 in preferred embodiments of the invention involves ranking the matches in global match list GM based on the scores. This step is optional, but by ranking the matches the likelihood that correct answers to the question will be presented before incorrect answers will be maximized. In step 260, the answers are presented along with optional information such as the rank, combined score, and/or identifiers or locations for documents in which the answers were identified.

Although for purposes of illustration the examples above have presented cases in which only a single match is found for a partially unspecified query, in accordance with the present invention a plurality of distinct matches may be identified. Furthermore, multiple instances of one or more of the matches may be identified. In accordance with the invention, as described above, a plurality of distinct matches may be identified as an answer to the question. Preferably the matches are ranked. In certain embodiments of the invention a score is assigned to the matches, the score preferably reflecting the number of times an instance of the match is identified.

The Information Need application fully describes using a set of contexts created from documents in a database corresponding to strings containing given terms found in the documents. In certain preferred embodiments, the contexts are stored as finite state automata. The inventive system locates matches for the query within the set of contexts rather than searching for matches within the documents themselves, thereby providing an opportunity for faster and more efficient processing of the query. As the system locates matches among the contexts it also accumulates information related to the matches, which may used to rank the located matches. Additionally, in addition to storing the contexts themselves, in certain embodiments information about the contexts is also stored, such as the position of the context within the document, the age of the document in which the context appears, or the co-occurrence of certain words within the context. In certain preferred embodiments, for a given term, not only are the words constituting the context stored, but also analyses of the sequence of those words.

Note that either an entire match, or a portion thereof that corresponds to a partially unspecified term can be provided as an answer. For example, the name Alexander Graham Bell rather than a complete sentence such as Alexander Graham Bell invented the telephone can be provided, or the date 1890 rather than a complete sentence such as Agatha Christie was born in 1890 can be provided. In certain embodiments of the invention, only one or a subset of identified answers are provided as an answer to a question. For example, if the great majority of located matches are instances of a particular match M, then it is likely that match M represents a correct answer to the question. In such a case it may be desirable to present only that answer rather than additional answers that are much less likely to be correct. In addition to providing an answer or answers to a question, in certain embodiments of the invention, document identifiers or locations for the documents that contain the answer may be presented with the answer.

The following sections of the application present additional aspects of the invention in certain preferred embodiments.

Question Answering with Extended Matching Techniques

As described in the Applicant's Extended Matching application, the techniques described above will solve many types of natural language questions, however there may be questions for which the techniques described above do not result in enough matches to create a high level of confidence in the answer(s). In such situations, it may be necessary to employ the search and matching techniques described in the Extended Matching application. Such situation may arise when, for example, there are superfluous words between the search terms of potential matches in the text being searched (e.g., Bell apparently invented the telephone.) The techniques will be only briefly discussed here, as they are described in detail in the Extended Matching application, which has been incorporated by reference herein. The Extended Matching application describes three methods for implementing unordered queries: using a simple extension of the technique of the Information Need application of storing contexts associated with document words without additional data structures; encoding a query using a finite state transducer in which all possible orderings of the query are represented, and using weights assigned to arcs of the finite state transducer to accumulate a score for a match that reflects the difference(s) between the query and the matching context; and using a new index structure identifying terms within documents that satisfy restrictions associated with partially unspecified terms, and intersecting document lists to identify matches.

Briefly, the techniques allow for an unspecified order among the matches of the wholly specified and partially unspecified terms of the query. For example, consider partially unspecified query

Senate [ADDRESS].

The partially unspecified query in extended matching will match addresses found in documents in which the word Senate occurs, regardless whether they occur in order or adjacent to each other.

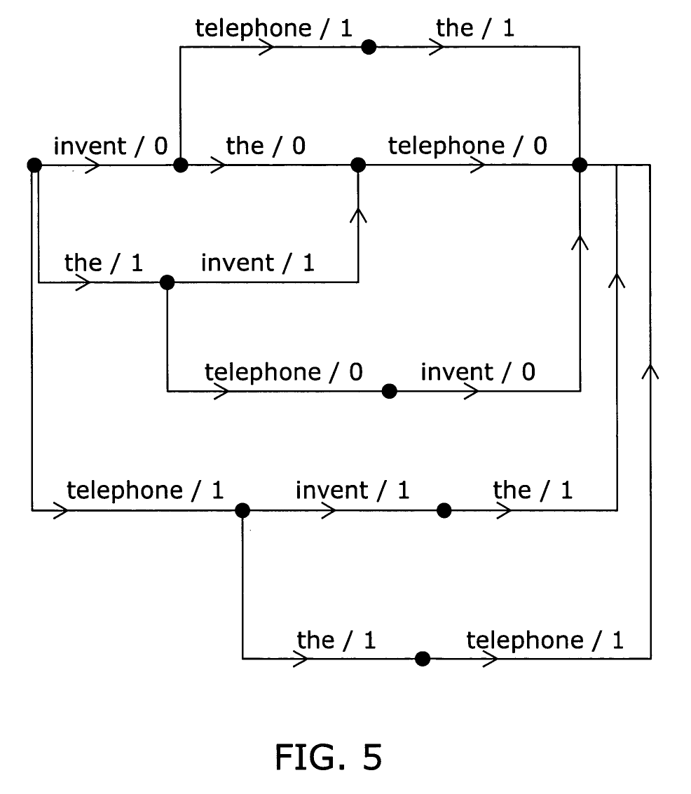

The second method described in the Extended Matching application involves encoding all possible orders of a query with a finite state machine/transducer. FIG. 5 illustrates a finite state machine/transducer which represents all possible orders of “invented the telephone” with an additive score associated with each arc. The scores on each arc are added to form a score of the strings (0 being a perfect order, 1 having a single permutation, etc . . . ). All possible orders of a query are encoded into one single finite state transducer. FIG. 5 does not include intervening words, but this may be addressed by adding loops (arcs originating from and arriving at the same state) matching any word on each state of the transducer. Partially unspecified terms may also be included in the finite state transducer. For each context selected by the method described in the Information Need application, the finite state transducer is matched against the context, and if the match is successful, matches of partially unspecified terms are collected and scored using the weights on the arcs.

In the third method, first the documents are analyzed in order to identify various sorts of linguistic entities such as person names, company names, phone numbers, addresses, and noun phrases. Then, an index comprised of the following data structure is built from the output of the analysis:

For each word appearing in the documents, a list of document identifiers in which the word appears is associated; and

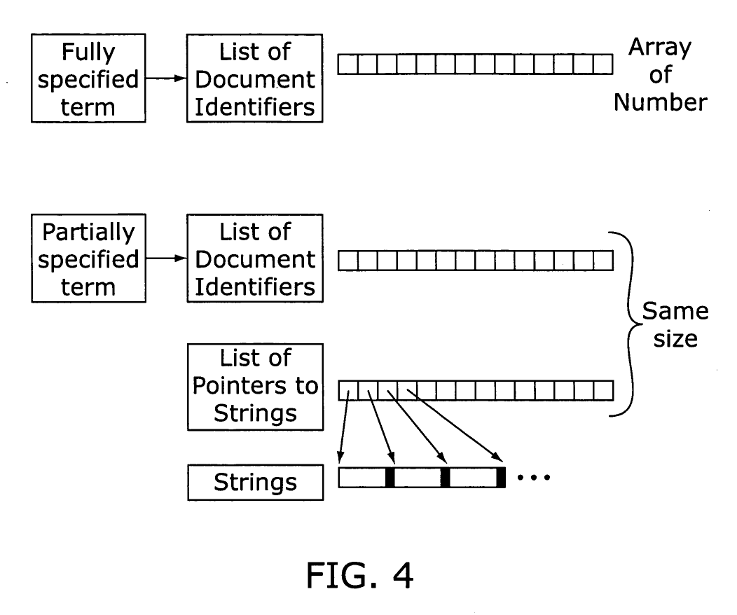

For each concept extracted during linguistic analysis (such as person names, phone numbers, . . . ), a list of document identifiers are each associated with the strings which match the concept in the associated documents is built. (FIG. 4 illustrates the data structures.)

Referring back to the example, comprised of one partially specified term [ADDRESS] and one fully specified term Senate. Both the list of document identifiers corresponding to the specified term, and the list of document identifiers with the associated strings corresponding to the partially specified term are extracted. Then, the system proceeds to intersect the sets of documents found in the two lists while collecting the strings for the documents found in both lists. This process may be easily extended to an arbitrary number of query search terms.

Extended matching may also solve ordered queries, i.e. queries in which some terms in the queries must appear adjacent to one another. A convention has been adopted in the Extended Matching application of identifying such terms by enclosing such terms in double quotes. For example, the query

“[FIRSTNAME] Clinton”

will extract all the names (such as Hillary, Bill and Chelsea) which immediately precede the word Clinton in the documents.

The previous implementation can be easily combined to form queries in which some terms must be in a precise order, and others may appear in any order. For example, the query

“[FIRSTNAME] Gates” [COMPANY]

will result in first names immediately preceding the word Gates and the company names which occur before or after the string “FIRSTNAME Gates”. Boolean operators can also be easily added to the query.

In another embodiment, the invention employs an extended parsing technique by which a natural language question such as

who did invent the omnipresent telephone? has terms which are considered important extracted, generating a partially unspecified statement

who invent telephone.

Then this partially unspecified statement is run through the extended matching technique. This approach allows the inventive system to handle questions not otherwise answerable.

Use of Thesaurus

In certain preferred embodiments of the invention, in order to collect more answers for a natural language question 110, a thesaurus is used to rephrase the natural language question 110, the partially unspecified statement(s) 140 corresponding to natural language question 110, or the set of partially unspecified queries 150 corresponding to natural language question 110 using words, phrases, or expressions that are synonyms of portions therein. The rephrasing is accomplished by substitution of equivalent words or phrases from previously defined tables similar to the FRAMES described earlier.

For example, in the query

Where are Arabian horses are bought?

The verb purchased could be used instead of the verb bought. Thus, using dictionaries of synonyms of words and expressions, the invention will transform the previous question into the following partially unspecified queries (among others):

Arabian horses are bought _[LOCATION]

Arabian horses are purchased _[LOCATION]

The answers of each of these partially unspecified queries 150 are combined to form one single set of answers by combining the score and counts of each query and ranking the answers based upon the combined score.

One aspect the present invention comprises a contextual thesaurus that is useful for expanding the set of statements and corresponding queries for a natural language question 110. In contrast to a traditional thesaurus, which presents synonyms for words, phrases, etc. independent of context, the contextual thesaurus of the present invention takes context into consideration in offering appropriate replacements for words or phrases within statements or queries. Briefly, the contextual thesaurus utilizes a syntactic and morphological analysis (performed as described in the references mentioned above) of an input question or statement and then suggests appropriate equivalent words or phrases that may be used to replace words or phrases in the input question or statement while preserving the meaning of the question or statement. In effect, the contextual thesaurus selects from among all possible synonyms as would appear in a traditional thesaurus, those that are appropriate given a particular context. The contextual thesaurus may be used independently of the question and statement transformation aspects and the matching aspects of the present invention. Although the contextual thesaurus is particularly helpful in the setting of the present invention, it may of course be used in a wide variety of other applications. The nature of the contextual thesaurus is illustrated by the following two examples, which discuss compound nouns and adjectives.

### EXAMPLE ONE

Compound Noun

In a traditional thesaurus, synonyms for the noun battle include the words fight and combat. However, although equivalent in some situations, these words are not interchangeable in all contexts. Thus for the phrase battle plan, the word combat is a contextually appropriate synonym for the word battle, since the phrase combat plan is grammatically and logically correct. However, the word fight is not a contextually appropriate synonym for the word battle since the phrase fight plan is unacceptable according to normal English usage. Thus if the phrase battle plan appears in a question or statement, the contextual thesaurus allows the generation of additional equivalent queries or statements in which the phrase battle plan is replaced by combat plan but avoids generating contexually inappropriate phrases in which battle plan is replace by fight plan.

### EXAMPLE TWO

Adjectives

It will be appreciated that adjectives may have different meanings depending upon context. A partial set of synonyms for the adjective bright may include the words clever, intelligent, smart, gifted, sharp, luminous, intense, vivid, etc. However, only the first five of these is appropriately applied to an animate being or an idea, as in bright man, clever man, intelligent man, etc. The final three are appropriately applied to a color or to a light as in bright color, intense color. By taking context into consideration, the contextual thesaurus recognizes that if the adjective bright precedes an animate being or an idea (among others), then appropriate synonyms include the first five words listed above but not the final three. On the other hand, if the adjective bright precedes the word color or the word light, the contextual thesaurus recognizes that appropriate synonyms include the final three words in the list above but not the first five.

As illustrated by the examples above, by taking context into consideration, the contextual thesaurus allows the selection, from among all synonyms for a word or phase considered without respect to context, those that are acceptable according to normal usage. Of course the contextual thesaurus is not limited to the examples described above.

Yes/No Questions

The questions presented above are characterized in that they contain an identifiable question word. However, in preferred embodiments, the present invention also provides methods for answering yes/no questions, i.e., questions that may be answered with “yes” or “no” answer.

Yes/no questions may be answered by a positive or a negative statement. For example,

Did Alexander Graham Bell invent the telephone?

is a yes/no question since its answer is yes. The system is able to answer yes/no questions by first transforming a yes/no question to a regular question (i.e., defined herein as a question that includes a question word) and then finding an answer to the regular question. If no answer is found using the previously described technique, a negative answer (no) is given to the yes/no question. If one or more answers are found, a positive answer (yes) is given to the yes/no question.

Certain types of yes/no questions are matched against a set of yes/no templates that transform a yes/no question to a regular question. The templates may then be mapped to partially unspecified queries as described above. The following examples illustrate the technique.

### EXAMPLE ONE

Yes-No Question: Do you know who invented the telephone?

Question Template: Do you know QUESTION

Regular Question: QUESTION

The queries corresponding to QUESTION are issued. In other words, the queries corresponding to

Who invented the telephone?

are issued.

### EXAMPLE TWO

Yes-No Question: Can you tell me who invented the telephone?

Question Template: Can you tell me QUESTION

Regular Question: QUESTION

The queries corresponding to QUESTION are issued. In other words, the queries corresponding to

Who invented the telephone?

are issued.

Other types of yes/no questions are handled by isolating a statement that occurs within the question. The statement is then transformed into an appropriate query. Matches are identified for the queries. If matches are found, this indicates that the correct answer to the question is “yes”. If no matches are found this indicates that the answer is “no”. Note that these queries are fully specified, but the matching process nevertheless proceeds as described. This method for handling yes/no questions is illustrated in the following example.

### EXAMPLE THREE

Yes/No Question: Did Alexander Graham Bell invent the telephone?

Question Template: Did STATEMENT?

Statement: STATEMENT

Queries: Alexander Graham Bell invented the telephone the telephone was invented by Alexander Graham Bell

Since the present invention relies on answers to partially unspecified queries or matches for fully specified queries for the yes/no answer, in addition to giving a positive or negative answer to a yes/no question, the present invention also presents evidence for the positive statements in the form of answers for the corresponding partially unspecified queries. In other words, the existence of matches for the corresponding partially unspecified queries (which can be displayed to a user) serves as validation of a positive answer.

Additional Search and Matching Technique

It is to be understood that the invention is not limited to operating on simple questions such as those presented above or on questions that contain a clearly identifiable question word. Instead, the invention encompasses the use of partially unspecified queries in conjunction with the matching approach described herein to answer a wide variety of natural language questions 110.

As previously described, an early step in the method of the current invention is to linguistically analyze the text to be searched, in order to categorize terms and phrases where possible. It is not always possible to categorize every word or phrase in the text through syntactic analysis. For example, consider the natural language question 110

Which Red Sox pitcher won the Cy Young Award?

and assume that a list of all Red Sox pitchers has not been previously generated. It is desirable to recognize how Pedro Martinez is associated with Red Sox pitcher. More complex questions such as this one may be answered, in a preferred embodiment, by dividing the natural language question 110 up into two or more indirectly-linked, yet separately matchable partially unspecified queries 150, and comparing the resulting match lists. This may be accomplished sequentially or in parallel. In the sequential approach, a first step would be to solve an initial query

WHO Red Sox pitcher?

derived from natural language question 110 in order to obtain a match list of all Red Sox pitchers, such as

name1=Hideo Nomo, p1 name2=Pedro Martinez, etc.

Next, the match list results would be inserting into the remainder of natural language question 110, and the resulting statements used to match possible answers. For example, the insertions would result in

name1 won the Cy Young Award?=>Hideo Nomo won the Cy Young Award?

name2 won the Cy Young Award?=>Pedro Martinez won the Cy Young Award?.

And the statements on the right side of the arrows would be used in an attempt to match correct answers.

The method could also be performed in parallel. Two queries could be conducted in parallel:

Who Red Sox pitcher? results in name1, . . .

Who won the Cy Young Award? results in name 2, . . .

and in the next step the match list resulting from each of the separate queries could be compared to obtain an answer, that is, does

name1=name2.

This powerful technique allows for the answering of more complex questions in which the relation or association between different terms within the question is not immediately evident.

Working Model of the Invention

The computer program listing appendix contains the following files:

“frames.pm” is a PERL module file needed for program file “match.pl”, which contains tables framemap1, framemap2, and adjframes;

“frames.txt” is the FRAMES text file that is written by hand;

“makemap.pl” is a PERL program which automatically generates the tables framemap1, framemap2 and adjframes from the input file “frames.txt”;

“match.pl” is a PERL program which takes as input an analyzed question and produces partially unspecified statements using file frames.pm; and

“Example_Match_Input.txt” and “Example_Output.txt” are, respectively, an example input file to the program “match.pl” and the corresponding output.

Below are the listings of tables FRAMES, framemap1, framemap2, and adjframes referred to earlier in the application. The FRAMES table uses the following annotations:

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

While the invention has been described and illustrated in connection with certain preferred embodiments, many variations and modifications as will be evident to those skilled in the art may be made therein without departing from the spirit of the invention, and the invention is thus not to be limited to the precise details set forth above as such variations and modifications are intended to be included within the scope of the invention. It is intended that the specification and examples be considered as exemplary only, with the true scope and spirit of the invention being indicated by the following claims.

What is claimed is:

1. A method of answering a question based on information stored on a computer-readable medium comprising the steps of
receiving a question;
parsing the question to obtain an analyzed question;
matching the analyzed question to a set of predetermined question patterns to obtain matched question patterns;
transforming the matched question patterns into one or more partially unspecified statements, wherein each of the partially unspecified statements is missing a portion corresponding to an answer;
generating partially unspecified queries corresponding to the partially unspecified statements; and
obtaining answers by matching the partially unspecified queries to stored information.

2. The method of claim 1, wherein the transforming step further comprises:
transforming matched question patterns into one or more partially unspecified statements using syntactic frames.

3. The method of claim 1, further comprising the step of:
collecting answers from matching the partially unspecified queries across a plurality of documents in the stored information.

4. The method of claim 1, further comprising the step of:
ranking each obtained answer according to its frequency of matching.

5. The method of claim 1, wherein the stored information comprises a set of documents and an index identifying which documents within the set of documents contain terms or groups of terms answering the partially unspecified queries.

6. A method of answering a question based on documents stored on a computer-readable medium comprising the steps of:
storing contexts for terms, wherein a context occurs in a document;
receiving a question;
transforming the question into one or more partially unspecified queries; and
identifying a match or a set of matches for the one or more partially unspecified queries within the contexts, thereby providing an answer or a set of answers for the question.

7. A method for answering a question based on information stored on a computer-readable medium comprising the steps of:
receiving a question;
transforming the question into one or more partially unspecified queries; and
identifying a match or a set of matches within a body of information stored on a computer-readable medium for each of one or more of the partially unspecified queries, thereby providing an answer or a set of answers for the question.

8. The method of claim 7, wherein the partially unspecified query comprises a partially unspecified term.

9. The method of claim 7, wherein the question contains a question word or phrase and wherein the transforming step comprises:
replacing the question word or phrase with a partially unspecified term.

10. The method of claim 9, wherein the partially unspecified term comprises a restriction that is determined, at least in part, by the question word or phrase.

11. The method of claim 7, wherein the transforming step comprises:
transforming the question into one or more statement patterns; and
transforming one or more of the statement patterns into one or more partially unspecified queries.

12. The method of any of claims 7, 8, 9, 10, 11, further comprising the steps of:
generating additional partially unspecified queries by using a thesaurus; and
identifying a match or a set of matches within a body of information stored on a computer-readable medium for each of one or more of the additional partially unspecified queries.

13. The method of claim 12, wherein the thesaurus comprises a contextual thesaurus.

14. The method of any of claims 7, 12, or 13, wherein the identifying step comprises identifying a match or a set of matches for each of a plurality of partially unspecified queries, further comprising the step of:
combining the matches or sets of matches identified for each of a plurality of partially unspecified queries, thereby generating a combined result set for the question.

15. The method of any of claims 7, 12, or 13, wherein the identifying step comprises identifying a match or a set of matches for each of a plurality of partially unspecified queries, further comprising the steps of:
extracting a portion of each of a plurality of the identified matches; and
combining the extracted portions, thereby generating a combined result set for the question.

16. The method of claim 11, wherein the first transforming step comprises one or more of the following:
(a) analyzing the question, wherein the analyzing step comprises assigning a grammatical label to each of a plurality of elements in the question;
(b) simplifying the question;
(c) assigning an identifier to some or all of the grammatical labels in the question either before or after simplifying the question, thereby generating a processed question.

17. The method of claim 16, wherein a different identifier is assigned to each subject element, each object element, and each preposition element in the processed question, thereby uniquely identifying each subject element, each object element, and each preposition element in the processed question.

18. The method of claim 17, wherein the identifiers are numbers.

19. The method of claim 16, wherein the first transforming step comprises:
selecting one or more of a plurality of categories for the question or processed question, wherein a category comprises a set of sentence patterns that are grammatically related to one another, the sentence patterns each including one or more statement patterns; and
selecting one or more of the statement patterns from the one or more categories.

20. The method of claim 19, further comprising the steps of:
replacing a grammatical label in one or more of the selected sentence patterns with a partially unspecified term; and
replacing the remaining grammatical labels in the one or more selected sentence patterns with the corresponding elements from the question, thereby generating one or more partially unspecified queries.

21. The method of claim 19, further comprising the steps of:
adding grammatical labels indicating grammatically acceptable positions for modifiers to the selected sentence patterns;
replacing a grammatical label in one or more of the selected sentence patterns with a partially unspecified term; and
replacing the remaining grammatical labels in the one or more selected sentence patterns with the corresponding elements from the question, thereby generating one or more partially unspecified queries.

22. The method of claim 19, wherein the sentence patterns comprising a set of sentence patterns are grammatically related to one another in that each sentence pattern comprises a transformed version of a base sentence pattern, the base sentence pattern comprising one or more grammatical labels selected from the list consisting of subject elements, verb elements, object elements, and preposition elements and each transformed version comprises the same subject elements, verb elements, object elements, and preposition elements as the base sentence pattern.

23. The method of claim 22, wherein a transformed version is derivable from a base sentence pattern by subject the subject elements, verb elements, object elements, and preposition elements of the base sentence pattern to one or more of the following operations:
(a) permutation of the order of the elements;
(b) modification of the voice or aspect of a verb element; and
(c) addition of further grammatical labels, so as to generate a grammatically acceptable variant of the base sentence pattern.

24. The method of claim 16, wherein the simplifying step comprises performing one or more of the following operations on the question after analyzing the question:
(a) removing some or all auxiliary verbs and their corresponding grammatical identifiers;
(b) removing some or all words that appeared in the original question while retaining their corresponding grammatical identifiers; and
(c) (i) removing some or all words that form part of a noun phrase;
(ii) removing the grammatical identifiers for the words removed in step (i); and
(iii) retaining the grammatical identifier for the noun phrase.

25. The method of either of claims 14 or 15, further comprising the step of:
ranking the results in the combined result set.

26. The method of claim 25, further comprising the step of:
outputting some or all of the results in the combined result set in an order determined, at least in part, by the ranking.

27. The method of either of claims 14 or 15, further comprising the step of:
outputting an identifier or location of a document that contains a result.

28. The method of claim 25, further comprising the step of:
outputting an identifier or location of a document that contains a result.

29. An apparatus for answering a natural language question comprising:
a grammar comprising rules for constructing sentences for grammatical elements;
a parser employing the grammar in analyzing the natural language question and assigning a grammatical identifier to a plurality of grammatical elements in the question;
a set of predetermined question frames for transforming the analyzed question into one or more partially unspecified queries; and
a matching module for determining one or more answers to the natural language question by matching the one or more partially unspecified queries to information stored in a body of documents.

30. An apparatus for answering a natural language question comprising:
memory means to store a computer-executable process steps; and
a processor that executes computer-executable process steps so as
to receive a question,
to transform the question into one or more partially unspecified queries, and
to identify matches for the one or more partially unspecified queries in a body of information, thereby providing an answer to the question.

31. Computer-executable process steps stored on a computer-readable medium, the computer-executable process steps comprising:
code to receive a question;
code to transform the question into a partially unspecified query; and
code to identify a match for the partially unspecified query in a body of information, thereby providing an answer to the question.
